(19) United States
(12) Patent Application Publication
(10) Pub. No.: US 2002/0086699 A1
(43) Pub. Date: Jul. 4, 2002

(54) Control module for a mobile unit

(76) Inventor: Claus Erdmann Furst, Roskilde (DK)

Correspondence Address: HARNESS, DICKEY & PIERCE, P.L.C., P.O. BOX 828, BLOOMFIELD HILLS, MI, 48303, US

(21) Appl. No.: 10/017,842

(22) Filed: Oct. 23, 2001

Related U.S. Application Data
(60) Provisional application No. 60/243,287, filed on Oct. 26, 2000.

(51) Int. Cl. H04B 1/38

(52) U.S. Cl. 455/550; 455/575; 455/90

(57) ABSTRACT

The present invention relates to a control module for a mobile unit, the control module comprising a plurality of user operable control members and a multiplexing unit. In particular, the present invention relates to a plurality of user controllable/user accessible members, such as volume controls or switches, connected to an integrated control circuit, such as an ASIC, in order to multiplex a plurality of controls signals generated by the plurality of user controllable/user accessible members. The multiplexed control signal is provided from the ASIC to a DSP of the mobile unit for further processing.

### FIELD OF THE INVENTION

The present invention relates to a control module for a mobile unit comprising a plurality of user operable control members and a multiplexing unit. In particular, the present invention relates to a plurality of user controllable/user accessible members, such as volume controls or switches, connected to an integrated control circuit, such as an Application Specific Integrated Circuit (ASIC), in order to multiplex a plurality of controls signals generated by the plurality of user controllable/user accessible members. The multiplexed control signal is provided from the ASIC to a Digital Signal Processor (DSP) of the mobile unit for further processing.

### BACKGROUND OF THE INVENTION

Electronic equipment such as hearing aids including assistive listening devices, cellular phones, medical dispensing devices etc. typically require that one or several functions provided by the equipment are user controllable. Even though a lot of effort is spent on developing automatic and “intelligent” control programs and functions for users of such electronic equipment, many users still want to be able to, at least ultimately, intervene in the automatic function.

In the field of hearing instruments or—aids, effort has been spent on developing control algorithms that are capable of automatically adapting a gain or a frequency response of the instrument to various listening environments in which the hearing aid user must be able to communicate. This is particularly the case for the current generation of DSP-based hearing aids wherein the utilisation of powerful processors supports the development of such control algorithms. Nevertheless, it has been found that many users request hearing aids that include an option for manual intervention in e.g. frequency response settings or gain settings selected by such automatic control algorithms.

Most frequently the user of e.g. hearing aids would like to have a plurality of possibilities of interacting with the hearing aid. This requires a plurality of user operable control members which all have to be connected to the DSP of the hearing aid. In prior art systems each user operable control feature is connected the DSP separately. This prior art way of connecting the user operable control members to the DSP takes up unnecessary die and hybrid area. In addition, the wires with corresponding contact pads used for connecting each of the user operable control members with the DSP takes up unnecessary space within the housing of e.g. a hearing aid.

It is an object of the present invention to provide a control module including a plurality of user operable control members suitable for integration within compact electronic equipment, such as hearing aids, cellular phones, portable audio equipment etc.

It is a further object of the present invention to provide a control module being adapted to multiplex a plurality of user operable control signals into a single multiplexed control signal being available for further processing.

It is a still further object of the present invention to reduce the number of wires connecting the user operable control members and the DSP within compact electronic equipment, such as hearing aids, cellular phones, portable audio equipment etc.

### SUMMARY OF THE INVENTION

The above-mentioned objects and other objects are complied with by providing, in a first aspect, a control module for a mobile unit comprising:

a plurality of user operable control members, said plurality of user operable control members being adapted to provide a plurality of user operable control signals, and

means for multiplexing a first and a second control signal of the plurality of user operable control signals into a multiplexed control signal, said multiplexed control signal being available for further processing in the mobile unit so as to control a number of operation parameters of said mobile unit.

The term “user operable control member” designates control members such as a control knob, a button or a switch operated by a human operator. This human operator may be an individual carrying the mobile unit housing the user operable control members in question. The user operable control members may be adapted to respond to an applied pressure, force or torque.

The multiplexing means may be an integrated control circuit that may comprise an ASIC having characteristics specifically tailored for the specific application. This integrated control circuit is preferably designed in CMOS technology wherein a large number of logic functions or gates can be integrated on a very small area. Furthermore, CMOS technology also allows the integrated control circuit to be manufactured at very low costs due to the widespread use of CMOS in today's digital circuits. Alternatively, BiCMOS or Bipolar technologies may be utilised to provide higher performance analogue circuitry, if required, such as proprietary low-power and/or high precision analogue-to-digital converters.

The integrated control circuit may further be adapted to receive a timing signal, such as an external clock signal, from e.g. the DSP. The DSP may have a digital input port for receiving the multiplexed control signal transmitted from an output port of the integrated control circuit. The integrated control circuit may multiplex the plurality of incoming control signals in the time or frequency domain.

The integrated control circuit may be adapted to receive and multiplex analogue or digital control signals from the user operable control members.

Digital control signals may be generated by digital encoders integrated with the user operable control members, said digital encoders being adapted to sample the analogue control signals so as to provide digital values representing the value of the analogue control signals. Alternatively, the user operable control members may provide analogue control signals, which may be converted into digital control signals using an analogue-to-digital converter for each user operable control members. In this case the multiplexing is performed in the digital domain.

Alternatively, the multiplexing may be performed in the analogue domain. This would be the case when the user operable control members provide analogue control signals which are provided directly to the integrated control circuit/ASIC The multiplexed analogue control signal may then be converted into a multiplexed digital control signal using an analogue-to-digital converter being adapted to sample the multiplexed analogue control signal to provide a digital value representing the value of the multiplexed analogue control signal. The multiplexed control signal may be provided to the DSP for further processing.

The analogue-to-digital converters described above may provide digital values being a substantially linear representation of the value of the analogue control signals provided by e.g. a sigma-delta analogue-to-digital converter or a successive approximation converter.

Alternatively, the analogue-to-digital converter may be adapted to directly convert the values of the control signals into digital values which is a substantially logarithmic representation of the control signals, and hence of the value generated by the user operable control members.

The operation of the analogue-to-digital converters including sampling of the value of the control signals may be controlled by logic circuitry, e.g. in the form of a simple hardwired internal processor within the integrated control circuit.

The integrated control circuit may be adapted to update the digital value solely in response to a detected change in the control signals. This embodiment of the invention is particular advantageous for low-power applications and/or applications wherein the user operable control members are seldom manipulated, since it is possible to interrupt transmission of the control signals between detected changes in the control signal to conserve power. If an analogue-to-digital converter is utilised to sample a control signal and generate the digital value, this converter may be adapted to enter a power-conserving mode between detected changes in control signals.

The integrated control circuit may be adapted to transmit the output signal one or several times in response to the detected change in the control signal and subsequently interrupt the output signal until a next change of the user operated control members is detected. The interruption of the output signal is preferably implemented by utilising an integrated data transmission buffer with a high impedance state to transmit the output signal. By activating the high impedance state of the data transmission buffer, the transmission of the digital data signal may be interrupted. Several types of data transmission buffers may be utilised, such CMOS or Bipolar tri-state buffers or open collector/drain output buffers etc.

Alternatively, the integrated control circuit may be adapted to continuously transmit the output signal (when a power supply is present). This operation mode may be advantageous in applications where it is desirable, or required, that the current values of the user operable control members always can be determined, i.e. independent of whether or not the user operable control members recently have been manipulated. This could be relevant if the current value of the user operable control member is required for operating a piece of electronic equipment intermediately after it has performed a power up sequence and thus may be unaware of the correct current position.

In yet another embodiment of the invention, the integrated control circuit is adapted to sample the value of the control signal and update the digital value in response to a trigger signal supplied by an external device to a terminal of a number of externally accessible terminals on the integrated control circuit. This trigger signal may comprise a single pulse of a predetermined voltage level and/or of a predetermined duration or the trigger signal may comprise a sequence of pulses constituting a series of bits encoding a particular data pattern to which the integrated control circuit is adapted to respond. Alternatively, the integrated control circuit may be adapted to solely perform a sampling of the value of the control signal and a subsequent update the digital value in response to a presence of an external clock signal and otherwise enter the power saving mode. A clock detecting unit senses whether the external clock signal is present or not, and optionally whether the external clock signal is valid based on certain predetermined characteristics. Accordingly, this operation mode may be viewed as a “trigger sensitive” mode, wherein the trigger signal is constituted by the external clock signal. Thus, the external device may control the operation of the integrated control circuit and put it into the power saving mode by removing the external clock signal.

The integrated control circuit may, however, comprise its own clock generator providing one or several clock signals to control operations of the integrated control circuit. Such clock signals from an integrated clock generator may be utilised to clock a processor and/or the analogue-to-digital converter and/or correctly control a timing of the multiplexed output signal. By utilising one of the internally generated clock signals to control the timing of the multiplexed output signal, synchronous communication with the external device is supported. However, it is presently preferred to dispense with such a clock generator on the integrated control circuit in order to conserve power and die area. Instead clocking of the internal processor and/or the analogue-to-digital converter is preferably accomplished by adapting the integrated control circuit to receive an external clock signal from the external device to perform the clocking of the integrated control circuit. This clocking scheme also supports synchronous communication with the external device, since the external clock signal may control the timing of the multiplexed output signal from the integrated control circuit to the external device.

Furthermore, to save a terminal, the external clock signal and a power terminal may be integrated so that the voltage supply is conveyed to the integrated control circuit over the external clock line. This integrated functionality could be accomplished by using the external clock signal to drive an AC to DC voltage converter on the integrated control circuit.

In some embodiments of the present invention, the integrated control circuit may be adapted to provide bidirectional communication. This may be implemented by integrating the external clock signal and a digital data signal so that the digital data signal is provided from the integrated control circuit over the external clock line.

In a second aspect, the present invention relates to a method of processing user operable control signals in a mobile unit, said method comprising the steps of:

providing a plurality of user operable control signals, and

multiplexing a first and a second control signal of the plurality of user operable control signals into a multiplexed control signal, said multiplexed control signal being available for further processing in the mobile unit so as to control a number of operation parameters of the mobile unit.

In a third aspect, the present invention relates to a hearing aid comprising a control module, said control module comprising:

a plurality of user operable control members, said plurality of user operable control members being adapted to provide a plurality of user operable control signals, and

means for multiplexing a first and a second control signal of the plurality of user operable control signals into a multiplexed control signal, said multiplexed control signal being available for further processing in the hearing aid so as to control a number of operation parameters of said hearing aid.

In a fourth aspect, the present invention relates to a cellular phone comprising a control module, said control module comprising:

a plurality of user operable control members, said plurality of user operable control members being adapted to provide a plurality of user operable control signals, and

means for multiplexing a first and a second control signal of the plurality of user operable control signals into a multiplexed control signal, said multiplexed control signal being available for further processing in the cellular phone so as to control a number of operation parameters of said cellular phone.

### BRIEF DESCRIPTION OF THE DRAWINGS

Hereunder, a preferred embodiment of a control module according to the invention is described with reference to the accompanying drawings, where

FIG. 1 shows the architecture of the concept of the present invention with three user operable control members being connected to a common integrated control circuit, such as an ASIC, being adapted for multiplexing the three control signals from the three user operable control members,

FIG. 2 shows an example of how the control module according to the present invention may be implemented,

FIG. 3 shows an example of an assembled control module according to the present invention, and

FIG. 4 shows an example of an assembled control module according to the present invention where the internal parts of the user operable control members are at least partly visible.

### DETAILED DESCRIPTION OF A PREFERRED EMBODIMENT

In its simple form, the present invention relates to a control module for a mobile unit comprising a plurality of user operable control members and a multiplexing unit. In principle, a user operable control member may be any kind of user controllable/user accessible member, such as a volume control or any kind of switch. The multiplexing unit typically forms part of an integrated control circuit and is typically implemented as an ASIC inserted between the user operable control members and the DSP of the mobile unit.

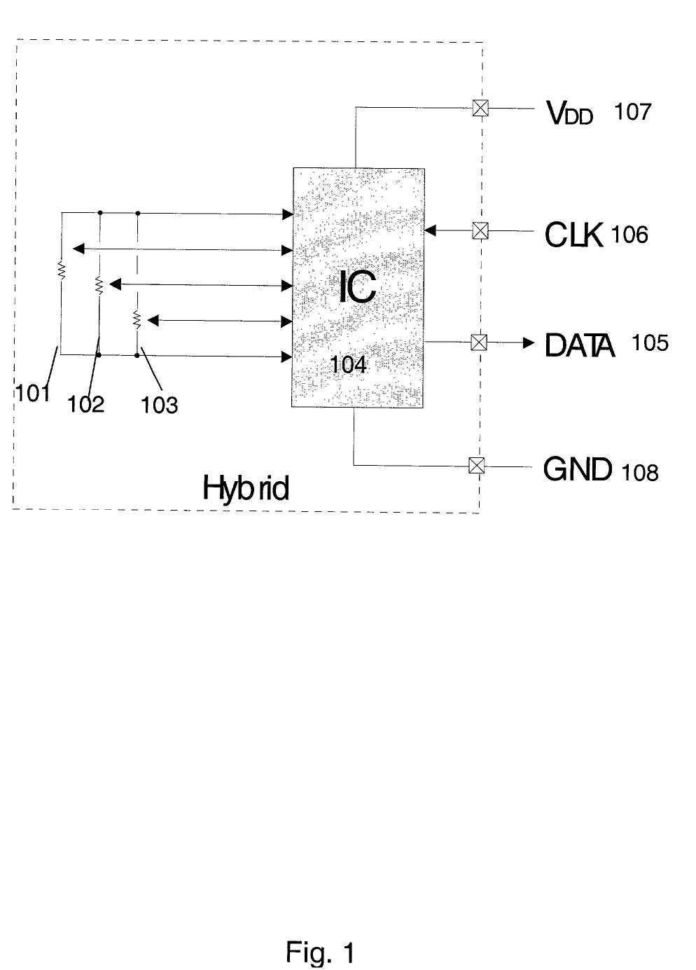

FIG. 1 shows a control module comprising three user operable control members 101-103 e.g. three potentiometers/trimmers—connected to an integrated circuit/ASIC 104 comprising the multiplexing unit. The control signals from the potentiometers/trimmers may be either in the analogue or in the digital domain. The control signals from the potentiometers/trimmers are connected to input terminals on the ASIC 104 so that the three input control signals may be multiplexed into a single control signal 105 which may be forwarded from the ASIC to the DSP (not shown). In order to process the multiplexed control signal, the DSP includes an analogue or a digital de-multiplexing unit.

The processing of multiplexing in the ASIC can be performed as either time or frequency multiplexing or a combination thereof. Time or frequency multiplexing or the combination thereof may be performed in the analogue or in the digital domain. In case the control signals from the potentiometers/trimmers are analogue signals, these may be multiplexed directly—i.e. as analogue signals. The resulting multiplexed control signal may afterwards be converted into a digital multiplexed control signal and forwarded to the DSP for further processing.

Alternatively, the analogue control signals from each of the potentiometers/trimmers 101-103 can be converted into digital signals prior to multiplexing using analogue-to-digital converters inserted between the potentiometers/trimmers 101-103 and the ASIC 104. In this case the multiplexing is performed in the digital domain. The resulting digital multiplexed control signal may then be directly forwarded to the DSP for further processing.

Beside receiving and multiplexing control signals from user operable control members 101-103, the ASIC 104 is adapted to forward the multiplexed signal to the DSP of the mobile unit for further processing. In order to communicate with the DSP in a controllable and synchronised manner, the ASIC 104 is further adapted to receive a timing signal, such as an external clock signal CL 106, from the DSP.

The ASIC, including the multiplexing unit, must be designed to operate on voltage supplies from about 0.9 volts to about 1.5 volts with an average current consumption of about 50 μA or less.

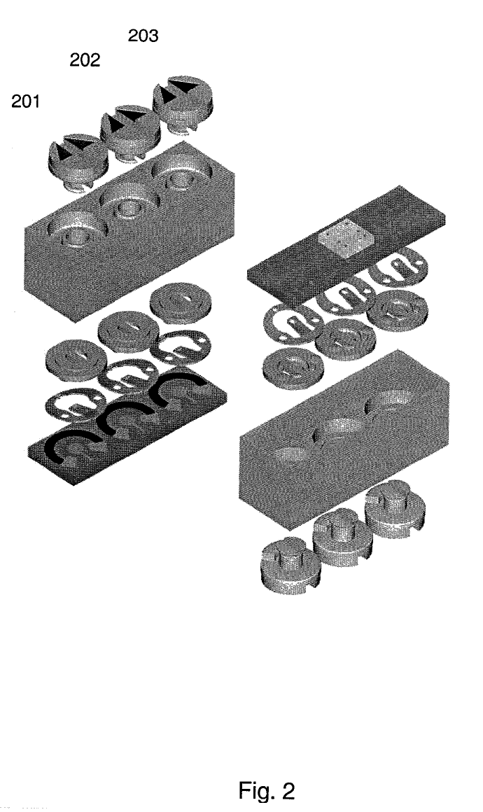

The control module may be implemented for example as illustrated in FIG. 2 where three user operable control members/knobs 201-203 are positioned in a base of plastic 204. Semi-circular resistor elements 206-208 are arranged on an upper surface 209 of a double-sided printed circuit board 205. Rotatable members 210-212 provide electrical contact points on the resistor elements 206-208 so as to form variable potentiometer wipers. The rotatable members 210-212 are attached to contact members 213-215 which are responsible for biasing the rotatable member 210-212 with a force that secures stable electrical connection between the members 210-212 and the semi-circular resistor elements 206-208. The contact members 213-215 are furthermore connected to the user operable control knobs 201-203 so that rotation of these control knobs are conveyed to the rotatable members 210-212. Plated through-holes 216 located at end parts of the semi-circular resistor elements 206-208 provide electrical connection from a wiper voltage to a conductor located on a lower surface 217 of the printed circuit board 205. Furthermore, FIG. 2 shows the integrated control circuit/ASIC 218 attached to the lower surface 217 of the printed circuit board 205.

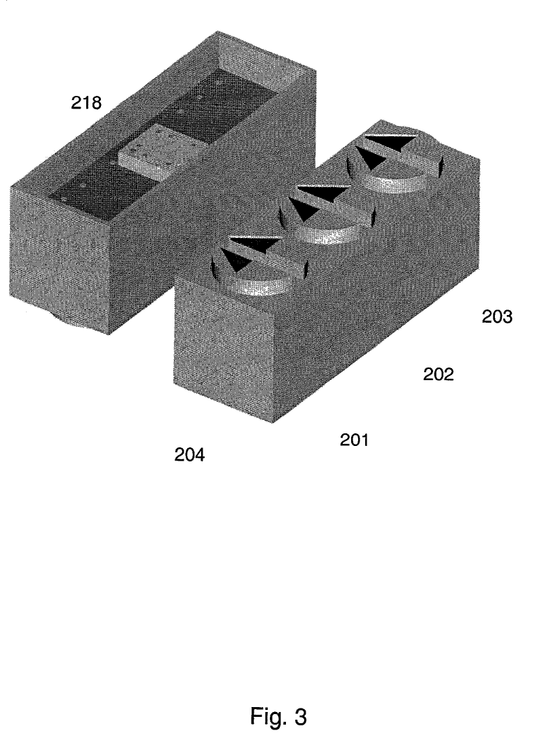

Wire bonding may be utilised to provide electrical connections between pads 219 on the integrated control circuit 218 and a number of corresponding connection pads 220 disposed on the lower surface 217. This is shown in FIG. 3. The wires used for making these connections may be gold wires.

Appropriate supply voltages may be supplied to a number of connection pads 220 on the lower surface 217 and as well to the integrated control circuit 218. Other contact pads may be connected to ground.

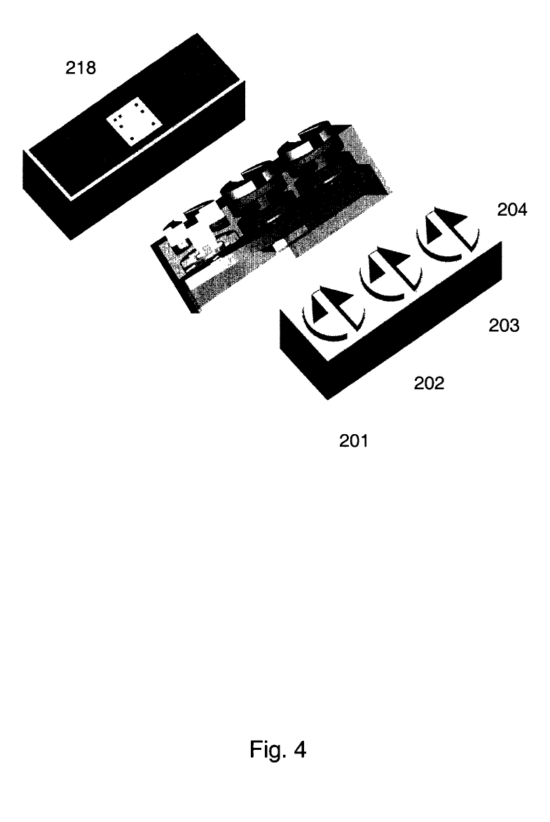

FIGS. 3 and 4 show assembled control modules according to a preferred embodiment of the present invention. Rotatable user operable control knobs 201-203 are mounted in the base 204 and provided with a number of protrusions on a front surface to assist the user in manipulating the control knobs 201-203. The control module has been designed so that the rotational angle of the user operable control knobs 201-203 is about 270 degrees, since this rotation angle causes the wiper to transverse the semi-circular resistance elements 206-208 (see FIG. 2) from a first to a second end point. Electrical connections to the interior of a hearing aid are provided by electrical leads soldered to a number of connection pads on the integrated circuit. In the case of a hearing aid, the control module is typically mounted in the faceplate of an ITE (In-The-Ear) or ITC (In-The-Canal) hearing aid. Accordingly, control knobs 201-203 protrude from a surface part of the ITE or ITC hearing aid and can be manipulated by the hearing aid user to control the operation of the hearing aid.

Beside being connected to the semi-circular resistance elements 206-208 and an appropriate power supply, the integrated control circuit is also connected to the DSP of the hearing aid. One contact pad on the integrated circuit is used as an output signal port for transmitting the multiplexed signal to the hybrid for further processing. Additionally, an input signal port is provided on the integrated circuit so that the timing signal, such as an external clock signal from the hybrid, can be received. The operation of the integrated control circuit 218 is controlled by an external clock signal provided via the input signal. The use of the external clock signal has the advantage that a power and die area consuming internal clock generator is superfluous. A frequency of the external clock signal is preferably selected within the interval 2-100 kHz, such as about 32 kHz.

1. A control module for a mobile unit comprising:
a plurality of user operable control members, said plurality of user operable control members being adapted to provide a plurality of user operable control signals, and
means for multiplexing a first and a second control signal of the plurality of user operable control signals into a multiplexed control signal, said multiplexed control signal being available for further processing in the mobile unit so as to control a number of operation parameters of said mobile unit.

2. A control module according to claim 1, wherein the multiplexing means further comprises a timing input terminal, said timing input terminal being adapted to receive a timing signal/clock signal.

3. A control module according to claim 1, wherein the multiplexing means comprises an integrated circuit for multiplexing the first and second user operable control signals in the analogue domain.

4. A control module according to claim 3, further comprising an analogue-to-digital converter for receiving the multiplexed analogue control signal and for outputting a multiplexed digital control signal.

5. A control module according to claim 1, further comprising analogue-to-digital converters for receiving the first and second user operable control signals and for converting these analogue control signals into digital control signals.

6. A control module according to claim 5, wherein the multiplexing means comprises an integrated circuit for multiplexing the first and second user operable control signals in the digital domain.

7. A control module according to claim 1, wherein the mobile unit is a cellular phone, a hearing aid, or a pager.

8. A control module according to claim 1, wherein the multiplexing means multiplexes the first and second user operable control signals in the time domain.

9. A control module according to claim 1, wherein the multiplexing means multiplexes the first and second user operable control signals in the frequency domain.

10. A method of processing user operable control signals in a mobile unit, said method comprising the steps of:
providing a plurality of user operable control signals, and
multiplexing a first and a second control signal of the plurality of user operable control signals into a multiplexed control signal, said multiplexed control signal being available for further processing in the mobile unit so as to control a number of operation parameters of the mobile unit.

11. A method according to claim 10, wherein the multiplexing of the first and second user operable control signals is performed in the time domain.

12. A method according to claim 10, wherein the multiplexing of the first and second user operable control signals is performed in the frequency domain.

13. A method according to claim 10, wherein the provided plurality of user operable control signals are provided in a digital format.

14. A method according to claim 10, wherein the provided plurality of user operable control signals are provided in an analogue format.

15. A method according to claim 10, wherein the mobile unit is a cellular phone, a hearing aid, or a pager.

16. A hearing aid comprising a control module, said control module comprising:
a plurality of user operable control members, said plurality of user operable control members being adapted to provide a plurality of user operable control signals, and
means for multiplexing a first and a second control signal of the plurality of user operable control signals into a multiplexed control signal, said multiplexed control signal being available for further processing in the hearing aid so as to control a number of operation parameters of said hearing aid.

17. A cellular phone comprising a control module, said control module comprising:
a plurality of user operable control members, said plurality of user operable control members being adapted to provide a plurality of user operable control signals, and
means for multiplexing a first and a second control signal of the plurality of user operable control signals into a multiplexed control signal, said multiplexed control signal being available for further processing in the cellular phone so as to control a number of operation parameters of said cellular phone.
